(19) United States
(12) Patent Application Publication
(10) Pub. No.: US 2014/0354806 A1
(43) Pub. Date: Dec. 4, 2014

(54) SELF-ADAPTIVE POSITIONING DEVICE FOR DETECTION REGION AND PRODUCT THEREOF

(71) Applicant: Generalplus Technology Inc., Hsinchu City (TW)

(72) Inventors: Zhi-Hung OU, Yilan County (TW); Shih-Chien LIN, Miao Li City (TW)

(73) Assignee: Generalplus Technology Inc., Hsinchu City (TW)

(21) Appl. No.: 14/154,099

(22) Filed: Jan. 13, 2014

(30) Foreign Application Priority Data
May 29, 2013 (TW) 102118888

(51) Int. Cl. H04N 7/18

(52) U.S. Cl. CPC H04N 7/183
USPC 348/143

(57) ABSTRACT

A self-adaptive positioning device for detection region and a product thereof are provided in the present invention. The self-adaptive positioning device for detection region includes a housing, a marking object and a detector. The shell includes an aperture. The marking object is disposed on a preset position behind the center point of the aperture in the shell. The detector has a detection region. The region forming by the marking object and the edge of the aperture is analog to the detection region. Therefore, when a user can see the marking object, it means that the user is in the detection region.

This application claims priority of No. 102118888 filed in Taiwan R.O.C. on May 29, 2013 under 35 USC 119, the entire content of which is hereby incorporated by reference.

### BACKGROUND OF THE INVENTION

1. Field of the Invention

The invention relates to a technology for defining a detection region, and more particularly to a self-adaptive positioning device for detection region and a product, wherein user can conveniently determine the region of usage.

2. Related Art

With the progress of the technology, the electronic technology has been progressed from the earliest vacuum tube and transistor to the integrated circuit chip, which has the quite wide applications. Thus, the electronic products have gradually become the indispensable essentials in the life of the modern human beings. The present human body sensing control system, such as face detection, gesture detection and human-based detection, requires a monitor to allow users to view their own face, body type or limbs to ensure that the sensed item is in the sensing range. If there is no monitor, user would not know whether his/her position could be sensed, they may have a sense of doubt and uncertainty, and they may have a poor user experience. Moreover, if the product is built in a display apparatus, to let the user know whether he/she is in the sensing range, the hareware cost of the product will be on the high side. Due to high cost of the product, the associated application of the human body sensing control system can not be widespread.

### SUMMARY OF THE INVENTION

In view of the above-identified problems, it is therefore an object of the invention to provide a self-adaptive positioning device for detection region and a product. Thus, user can determine whether he/she is in the sensing region or not without any display apparatus.

To achieve the above-identified object, the invention provides a self-adaptive positioning device for detection region. The self-adaptive positioning device for detection region includes a housing, a marking object and a detector. The housing includes a marking aperture. The marking object is disposed on a preset position behind the center point of the marking aperture in the housing. The detector has a detection region. The region forming by the marking object and the edge of the marking aperture is substantially the same as the detection region, such that a user is in the detection region when a user can observe the marking object.

An electrical product is provided in the present invention. The electrical product has an applied region. The electrical product includes a housing and a marking object. The housing includes a marking aperture. The marking object is disposed on a preset position behind the center point of the marking aperture in the housing. The region forming by the marking object and the edge of the marking aperture is substantially the same as the applied region, such that a user is in the applied region when a user can observe the marking object.

According to the self-adaptive positioning device for detection region and the electrical product of a preferred embodiment of the present invention, the housing further includes a transparent cover. The transparent cover is disposed on the marking aperture, fitting the marking opening, wherein the user can observe the marking object through the transparent cover. In addition, the marking object may be a light emitting diode, wherein a user is in the applied region when a user can observe the light of the light emitting diode. In another preferred embodiment, the marking object may be a laser light emitting diode, for emitting the laser along an edge of marking aperture, wherein the scope depicting from the laser approximates the applied range such that a user is in the applied region when a user stands in the scope.

According to the electrical product of a preferred embodiment of the present invention, the electrical product is a digital camera or a video camera, and the electrical product further includes a camera shot. The camera shot has a shot range, wherein a photographed can determine whether the photographed is in the shot range according to whether or not the photographed can observe the marking object. In another preferred embodiment, the electrical product is a multi-channel audio system, and the electrical product further includes a tweeter. The tweeter has a tweeter unit and the housing, wherein the tweeter unit is disposed on the tweeter opening of the housing, and the tweeter opening and the marking aperture are disposed on the same plane. When the tweeter is to be installed, an installer determines a installed position and a installed direction according to whether or not the installer can observe the marking object.

The spirit of the present invention is that users can define the used region by themselves through the mechanical change of the housing. According to the mechanic of housing of the present invention and the internal marking object, user would know that he/she is in the applied range of the product when user can watch the marking object. Also, user would know that he/she is not in the applied range of the product when user cannot watch the marking object. User can conveniently adjust his/her position without a display. Therefore, the present invention can significantly reduce the cost of the product.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 illustrates a diagram depicting a front view of a self-adaptive positioning device for detection region according to a preferred embodiment of the present invention.

FIG. 2 illustrates a diagram depicting a top view of a self-adaptive positioning device for detection region according to a preferred embodiment of the present invention.

FIG. 3 illustrates a diagram depicting a top view of a self-adaptive positioning device for detection region according to a preferred embodiment of the present invention.

FIG. 4 illustrates a diagram depicting a top view of an electrical product according to a preferred embodiment of the present invention.

FIG. 5 illustrates a diagram depicting a top view of a electrical product according to a preferred embodiment of the present invention.

### DETAILED DESCRIPTION OF THE INVENTION

The present invention will be apparent from the following detailed description, which proceeds with reference to the accompanying drawings, wherein the same references relate to the same elements.

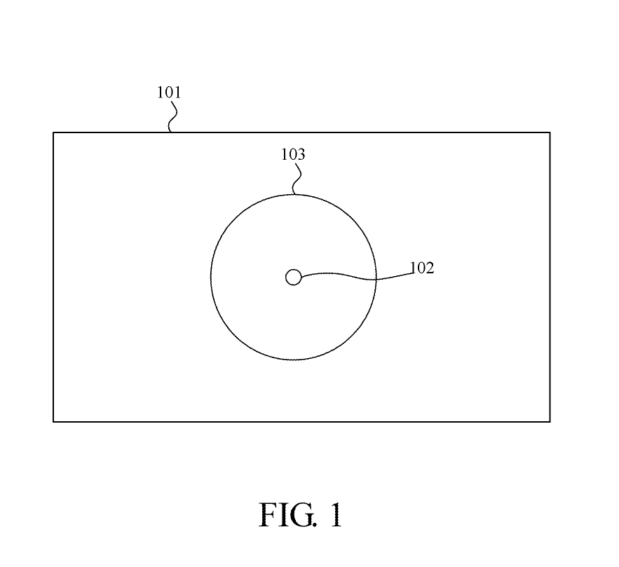

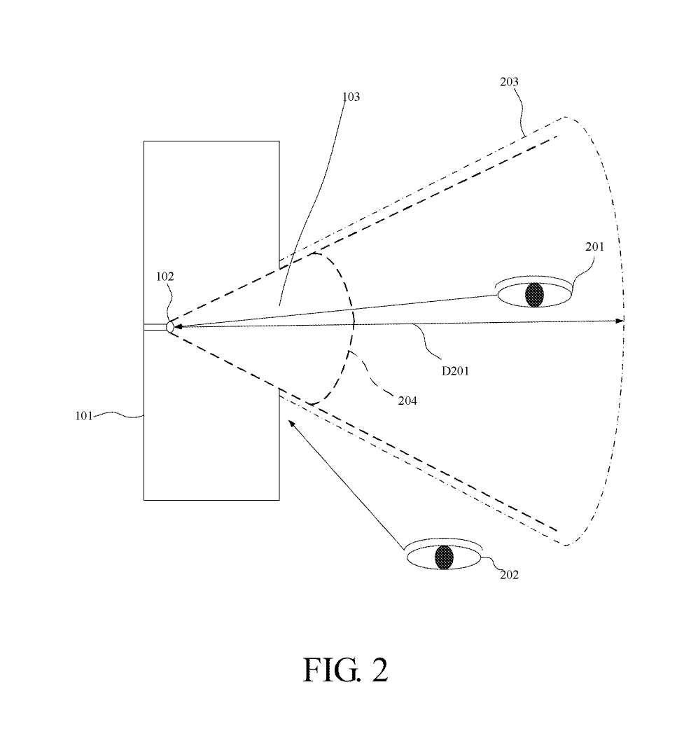

FIG. 1 illustrates a diagram depicting a front view of a self-adaptive positioning device for detection region according to a preferred embodiment of the present invention. Referring to FIG. 1, the self-adaptive positioning device for detection region includes a housing 101, a marking object 102 and a marking aperture 103. FIG. 2 illustrates a diagram depicting a top view of a self-adaptive positioning device for detection region according to a preferred embodiment of the present invention. Referring to FIG. 1 and FIG. 2, as shown in FIG. 2, the marking object 102 is fixed and disposed behind the center of the marking aperture 103 for a distance. In order to conveniently describe the spirit of the present invention, in FIG. 2, two eyes 201 and 202 are illustrated for respectively representing positions of two users. The detection region or an applied region for product 203 is also illustrated.

According to FIG. 2, there is an intersection angle 204 between the marking object 102 and the edge of the marking aperture 103. The eye 202, which is not in the intersection angle 204, cannot observe the marking object 102. Only the eye 201 in the intersection angle 204 can watch the marking object 102. In addition, even a person in the intersection angle 204, his/her eyes generally has a certain vision, and he/she may not see the small object or a far object. Thus, it defines the detection region or the applied region 203. Generally speaking, the distance D201 of region 203 may be designed greater than the visual distance of the person. The distance D201 and the intersection angle 204 can enclose a sector. The sector substantially is the applied region or the detection region 203 which user's eye determines.

Thus, the product with the concept of the design, user can directly determine the detection region or the applied region with naked eye. User would not have a sense of doubt and uncertainty because there is no monitor to display the region. Furthermore, people having ordinary skill in the art should know that the detection region or the applied region 203 almost completely overlap with the region form by the intersection angle 204 between the marking object 102 and the edge of the marking aperture 103. However, in the implementation, it is unnecessary to 100% overlap, and it can allow a slight difference if it doesn't affect user's determination.

In order that people having ordinary skill in the art can understand the present invention, a practical product is taken as an example to describe the spirit of the present invention.

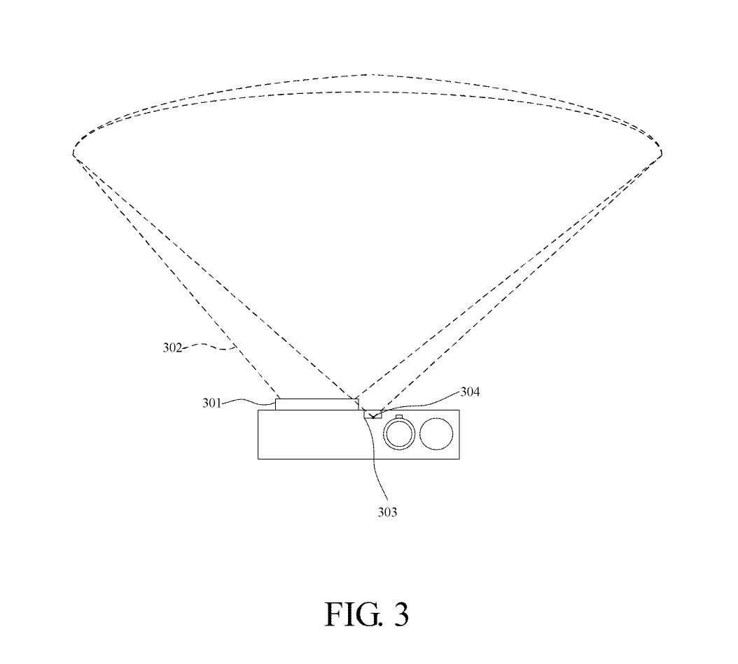

First, assume that the product is a digital camera as shown in FIG. 3. FIG. 3 illustrates a diagram depicting a top view of a self-adaptive positioning device for detection region according to a preferred embodiment of the present invention. Referring to FIG. 3, the digital camera includes a camera shot 301, the camera shot 301 has a shot region 302. In addition, the self-adaptive positioning device for detection region as FIG. 1 and FIG. 2 is labeled as 303. As shown in FIG. 3, the shot region 302 overlap with the region by the user's eyesight, but they does not completely overlap. When a group shot is to be performed, each photographed can determine whether or not his/her position is in the shot region 302 of the camera shot 301. Thus, the photographed can adjust his/her position. It can prevent some embarrassing situation, such as a half of photographed person is at outside of the photo. Also, the present invention can be applied to the selfie mode or the timed exposure mode, user can reduce the time for adjusting his/her position.

Moreover, the marking object 304 can use an LED (light emitting diode), and the marking aperture of the self-adaptive positioning device for detection region 303 can dispose in a transparent cover to prevent the dust. Also, user can observe the marking object 304 through the transparent cover.

Similarly, assume that the product is a video camera, security camera or a web camera for video conference. As shown in FIG. 3, user can the marking object 304 to determine whether he/she is in the shot range. In addition, when the product is a security camera, the shot range can be ensured when the engineer installs the security camera. Thus, the shot blind spot can be prevented. Further, when the product is a vehicle video recorder and the vehicle video recorder does not has a display, user can set-up the vehicle video recorder in the vehicle, and then go to the place in front of the windscreen to observe the marking object 304 to determine the shot angle. Therefore, the cost of the vehicle video recorder can be further reduced.

Furthermore, assume that the product is a face recognition system. User can observe the marking object of the face recognition system to determine whether the face is in the shot range. Thus, the face recognition can be performed.

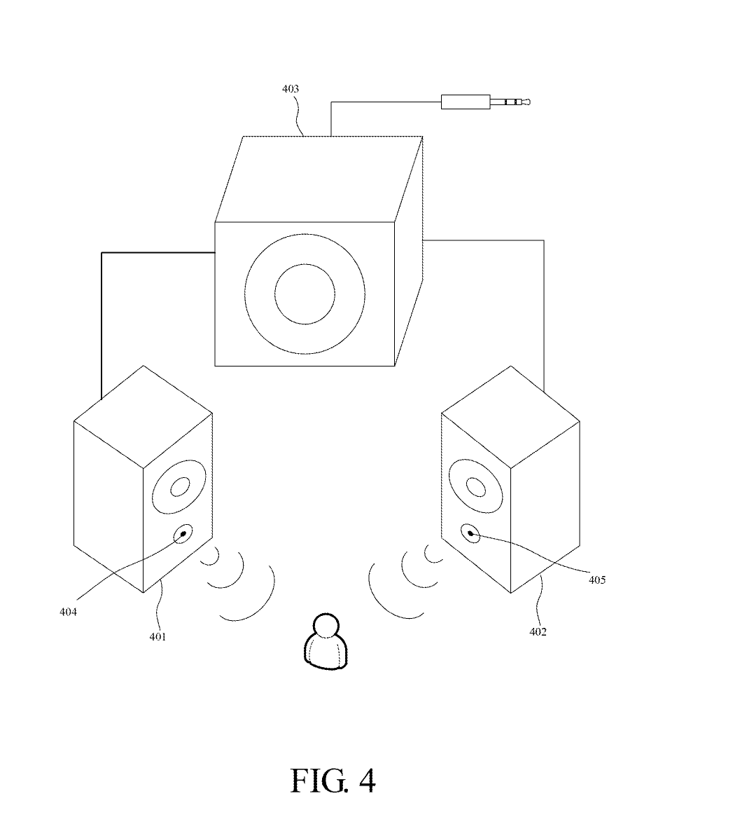

Next, assume that the product is a multi-channel audio system, as shown in FIG. 4. FIG. 4 illustrates a diagram depicting a top view of an electrical product according to a preferred embodiment of the present invention. Referring to FIG. 4, the multi-channel audio system includes a left surround speaker 401, a right surround speaker 402 and a subwoofer channel speaker 403. The system is a basic 2.1 channel audio system. Generally speaking, since bass dose not has directionality, the bass would not be affected even though the subwoofer faces the wall. However, the treble is directional. The best positions of the tweeters 401 and 402 is to respectively face the left ear and the right ear. Thus, when the installer installs the multi-channel audio system, the installer can refer to the marking objects 404 and 405 of the left surround speaker 401 and the right surround speaker 402 to ensure that the left surround speaker 401 faces the left side of the user and the right surround speaker 402 faces the right side of the user. In order to prevent the misjudgment, the marking objects 404 and 405 can be designed to have different colors. For example, the color of the marking object 404 of the left surround speaker 401 is red, and the marking object 405 of the right surround speaker 402 is green.

Further, the marking object 404 or 405 could be a laser diode with a mobile mechanism, for emitting the laser along an edge of marking aperture. The left surround speaker 401 and the right surround speaker 402 are generally installed on the wall. Thus, the laser light would form a circle on the ground. Since the region formed by laser light is similar to the applied region of the tweeter, user is in the best place when user stands on the region formed by laser light.

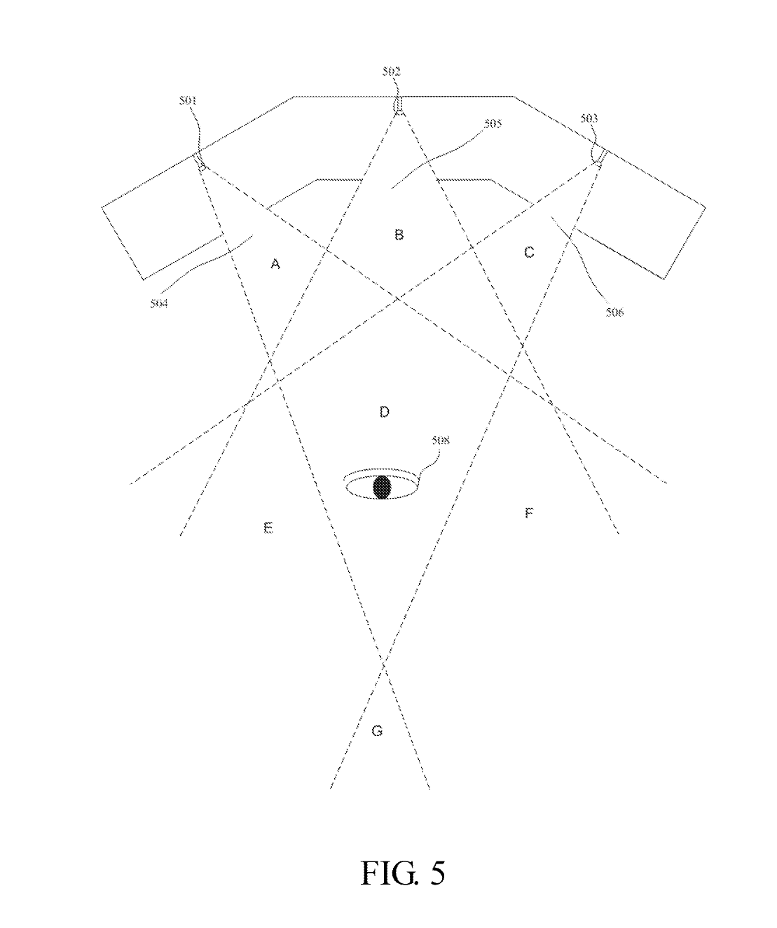

FIG. 5 illustrates a diagram depicting a top view of an electrical product with a self-adaptive positioning device according to a preferred embodiment of the present invention. Referring to FIG. 5, in this embodiment, the housing includes three marking objects 501, 502 and 503, which respectively face three directions. The three marking objects 501, 502 and 503 and the edges of the three apertures respectively form three regions 504, 505 and 506. The whole area can be divided into a plurality of small areas A˜G by the region 504, 505 and 506. In those small areas, only the intersection area D by the region 504, 505 and 506 can let user observe all of the marking objects 501, 502 and 503. If user stands at the area G or the area B, all of the three marking objects cannot be seen. Therefore, the area D is the applied region of the product. The user 508 in front of the product must stand on the place on which user can see all of the marking objects 501, 502 and 503, it represents that user stands on the applied region of the product.

Since the abovementioned embodiment in FIG. 5 uses a plurality of marking object, user can not only adjust the position of the left or right, but also adjust the position of front or back. Thus, the depth of correction can be introduced in the self-adaptive positioning device of the present invention. Moreover, the abovementioned embodiment in FIG. 5 can be applied to the digital camera, and the self-adaptive positioning device will make the user to stand the best position.

In summary, the spirit of the present invention is that users can define the used region by themselves through the mechanical change of the housing. According to the mechanic of housing of the present invention and the internal marking object, user would know that he/she is in the applied range of the product when user can watch the marking object. In addition, user would know that he/she is not in the applied range of the product when user cannot watch the marking object. User can conveniently adjust his/her position without a display. Therefore, the present invention can significantly reduce the cost of the product.

While the invention has been described by way of examples and in terms of preferred embodiments, it is to be understood that the invention is not limited thereto. To the contrary, it is intended to cover various modifications. Therefore, the scope of the appended claims should be accorded the broadest interpretation so as to encompass all such modifications.

What is claimed is:

1. An electrical product, having an applied region, the electrical product comprising:
a housing, including a marking aperture;
a marking object, disposed on a preset position behind the center point of the marking aperture in the housing,
wherein the region forming by the marking object and the edge of the marking aperture is substantially the same as the applied region, such that a user is in the applied region when a user can observe the marking object.

2. The electrical product according to claim 1, wherein the housing further comprises:
a transparent cover, disposed on the marking aperture, fitting the marking opening, wherein the user can observe the marking object through the transparent cover.

3. The electrical product according to claim 1, wherein the marking object is a light emitting diode, wherein a user is in the applied region when a user can observe the light of the light emitting diode.

4. The electrical product according to claim 1, wherein the marking object is a laser light emitting diode, for emitting the laser along an edge of marking aperture, wherein the scope depicting from the laser approximates the applied range such that a user is in the applied region when a user stands in the scope.

5. The electrical product according to claim 1, wherein the electrical product is a digital camera, and the electrical product further comprises:
a camera shot, having a shot range, wherein a photographed can determine whether the photographed is in the shot range according to whether or not the photographed can observe the marking object.

6. The electrical product according to claim 1, wherein the electrical product is a video camera, and the electrical product further comprises:
a video camera shot, having a shot range, wherein a photographed can determine whether the photographed is in the shot range according to whether or not the photographed can observe the marking object.

7. The electrical product according to claim 1, wherein the electrical product is a multi-channel audio system, and the electrical product further comprises:
a tweeter, having a tweeter unit and the housing, wherein the tweeter unit is disposed on the tweeter opening of the housing, and the tweeter opening and the marking aperture are disposed on the same plane,
wherein, when the tweeter is to be installed, an installer determines a installed position and a installed direction according to whether or not the installer can observe the marking object.

8. A self-adaptive positioning device for detection region, comprising:
a housing, including a marking aperture;
a marking object, disposed on a preset position behind the center point of the marking aperture in the housing; and
a detector, having a detection region,
wherein the region forming by the marking object and the edge of the marking aperture is substantially the same as the detection region, such that a user is in the detection region when a user can observe the marking object.

9. The self-adaptive positioning device for detection region according to claim 8, wherein the housing further comprises:
a transparent cover, disposed on the marking aperture, fitting the marking opening, wherein the user can observe the marking object through the transparent cover.

10. The self-adaptive positioning device for detection region according to claim 8, wherein the marking object is a light emitting diode, wherein a user is in the applied region when a user can observe the light of the light emitting diode.

11. The self-adaptive positioning device for detection region according to claim 8, wherein the marking object is a laser light emitting diode, for emitting the laser along an edge of marking aperture, wherein the scope depicting from the laser approximates the applied range such that a user is in the applied region when a user stands in the scope.
